(19) United States
(12) Patent Application Publication
(10) Pub. No.: US 2012/0284208 A1
(43) Pub. Date: Nov. 8, 2012

(54) Systems and/or Methods For Delivering Notifications On A Communications Network

(75) Inventors: Elias Blomqvist, Karlskrona (SE); Jose Maria Fuster Millan, Madrid (ES); Karl-Johan Östh, Karlskrona (SE); Ulf Kristiansson, Karlskrona (SE)

(73) Assignee: TELEFONAKTIEBOLAGET LM ERICSSON (publ), Stockholm (SE)

(21) Appl. No.: 13/102,339

(22) Filed: May 6, 2011

(51) Int. Cl. G06F 15/173; G06F 17/00

(52) U.S. Cl. 705/400; 709/224

(57) ABSTRACT

Embodiments described herein relate to sending notifications over mobile communications networks. At least one node in a communications network tracks resource usage. A consumption rate is calculated based on the track resource usage and is compared against another consumption rate. A notification message is triggered based on the comparison. A notification message is sent to a user equipment device based on the triggered event. Certain embodiments suppress notification messages based on notification criteria.

### TECHNICAL FIELD

The technical field relates to radio and/or wireless communications, and more particularly, to notification delivery systems and methods.

### BACKGROUND

Mobile networks are becoming increasing ubiquitous in society. Initially, mobile networks were used simply for voice communication. However, more recently other types of communication services have been adapted to mobile networks. Text messages, music and video streaming, email, web browsing, and others have all been adapted to work with mobile networks. This increase in breadth of service has coincided with society's increased reliance on the connectivity provided by mobile networks. For example, in the past, a customer may have watched a movie over a cable connection, now the movie may be sent to the user over a mobile network.

In certain instances, mobile network service to users may be provided by allocating a set amount of resources per user. For example, a user may pre-pay for 300 minutes, 20 texts, and/or 50 megabytes of data traffic for a given month. However, unless a user is scrupulous about keeping usage records, the user may be unaware of when (or if) the “cap” for that month has been reached. Thus, a user may continue to use the mobile service while being unaware of possible overage charges. This can lead to an unpleasant surprise when the user receives the monthly bill.

Mobile network capacity is typically unaffected by the time of day or day of the week. In contrast, the usage of mobile network resources may be tied to a particular time of day (e.g., increased usage during the daytime). Such a usage pattern inefficient uses the total capacity available in the mobile network. On way of addressing the “unevenness” in network utilization is to implement a management solution that aims to change subscriber call patterns in a mobile network. A conventional solution may seek to decrease network traffic at peak times and increase network traffic during quiet times. This may be accomplished by adjusting rates based on the time of day or the location of a call/data session. Such a solution may be implemented to help operators more efficiently use their network capacity.

A conventional technique for addressing the sticker shock and/or the network resource problem discussed above is to provide users with more information and/or incentive relating to their account and current network status. This is typically done through sending the user a notification to the device of the user. Examples of notifications include: 1) that a bonus has been given (“You have sent 10 SMS's in last 24 hours and you have received 2 free MMS's that can be used within the next 48 hours”; 2) the cost rate is announced (“Your current rate is 0.25 USD/minute”; 3) a limit has been passed (“Account balance is below 5 USD—refill now to avoid empty”); or 4) a rate has been changed (“Current rate has changed from 0.25 USD/min to 0.05 USD/min”) Such notifications my provide users with more up-to-date information on the status of their account (e.g., point 3) and may help to shape usage patterns (e.g., point 4).

Notifications are typically delivered through USSD, SMS or, if applicable, call announcements or IP based notification solutions. Notifications are usually triggered or sent based on a condition that is checked by the mobile communications network. One such condition may be the start of a phone call. Here, the user is notified of the current rate or applicable discounts. Next, when there is a change in a condition such as time, location, discount, etc, a new notification may be sent relating to the changed discount/rate/etc.

FIG. 21 shows an example of a voice call where each minute of the call consumes the same amount of resources (e.g., minutes of a voice call). At point 2100 a first notification may be sent that announces the rate. Then at point 2102 (after the call has lasted for 4 minutes) a rate change is announced. As can be seen, the trigger for this change is based on a fixed consumption pattern (e.g., after 4 minutes of usage the rate is lowered to a lower rate).

While the above system does provide a notification, it may not be sufficient in certain instances. For example, such an implementation may not help in providing a service provider with tools to efficiently manage network resources. Furthermore, such implementations may not be as helpful to users in certain instances either because the wrong information is provided and/or too much information is provided to a user (e.g., too many notifications). Accordingly, it would be desirable to provide systems and/or methods for providing improved notifications to users and their associated user equipment devices.

### SUMMARY

The inventors of the instant application determined that notifications based only on fixed consumption patterns may be less useful for users/service providers in certain instances. For example, a user may not be interested in notifications when the cost to the user is low. The low cost may be a result of low consumption or a low price per consumption charge (e.g., one dollar per megabyte). Conversely, a user may be more interested when the amount of data transferred is high and results in a higher overall cost for the user. Thus, certain example embodiments may send notifications based on the significance of the current cost to that user.

In certain example embodiments, notifications sent to a user may be sent when consumption or a value derived from consumption exceeds a threshold. The consumption value may be based on a tracked amount of resources of a time period.

In certain example embodiments calculated consumption values may be compared against threshold values that are predetermined or dynamically created. In certain example embodiments, calculated consumption values are compared against other calculated consumption values.

Certain example embodiments store a history of tracked resource usage and use the tracked history to compare multiple different calculated consumption values.

In certain example embodiments, a message may be suppressed by suppression criteria. The suppression criteria may result in decreasing the overall number of messages that are processed by a mobile network and sent to a customer.

In certain example embodiments, triggered notification events may be ordered according to a prioritization order.

In certain example embodiments, an operator may implement an active/passive service distinction between the consumption of resources.

In certain example embodiments, a user may receive notifications as to how to continue to use the mobile service based on personal preferences (e.g., preferences that are defined by the user of the mobile service provider).

Certain example embodiments provide a computer implemented method for providing a notification to a user equipment device. Mobile network resources consumed by a first user equipment device are tracked. A rate is calculated based on the track resources and a time period. The calculated rate is compared against another rate. Based on the comparison, a notification event is triggered. Based on the triggered notification event a notification message is sent to a second user equipment device.

In certain example embodiments the first and second user equipment devices are the same device. In certain example embodiments, the first and second user equipment devices are different user equipment devices.

Certain example embodiments provide a computer implemented method for sending a notification to a user. Resources are tracked or otherwise determined over first and second time periods. Resource usage relating to the first and second time periods are assigned predetermined or dynamically determined levels of consumption. First and second prices per consumption over the first and second time periods are assigned to respective levels. Based on the levels of consumption a first state and a second state are determined. A notification event is triggered based on the difference between the first state and the second state. A notification is sent to a user equipment device based on the notification event. The method may be embodied in a non-transitory computer readable storage medium.

Certain example embodiments provide a node that is configured to communicate with a communications network. The node may include a processing system where the processing system is configured to perform a method of sending a notification to a user.

Certain example embodiments may facilitate user knowledge of resource usage and/or improved network management of mobile resources.

### BRIEF DESCRIPTION OF THE DRAWINGS

FIG. 1 is a block diagram of a non-limiting charging system according to certain example embodiments;

FIG. 2 is a block diagram showing a non-limiting charging system in an example mobile network;

FIG. 3A is a non-limiting diagram of a network operator servicing respective subscribes with an exemplary charging node;

FIG. 3B is a signal diagram illustrating exemplary signals between a core network and a charging system;

FIG. 4 is a flow chart showing an example notification procedure according to certain example embodiments;

FIG. 5 is a block diagram showing exemplary consumption types used in certain example embodiments;

FIG. 6 is a flow chart showing an illustrative procedure for sending a notification;

FIG. 7 is an illustrative graph showing example call data according to certain example embodiments;

FIG. 8 is an illustrative graph showing notification conditions according to certain example embodiments;

FIG. 9 is another illustrative graph showing example call data and associated calculations used in certain example embodiments;

FIGS. 10-12 are illustrative charts showing example notification states according to certain example embodiments;

FIG. 13 is a flow chart showing a non-limiting state-based notification procedure;

FIG. 14 is an illustrative chart showing example state transitions according to certain example embodiments;

FIG. 15 is a flow chart showing another non-limiting state based notification procedure;

FIG. 16 shows two illustrative graphs of that show exemplary resource usage;

FIG. 17 shows an illustrative graph according to certain example embodiments;

FIG. 18 is a flow chart showing a non-limiting notification procedure;

FIGS. 19A and 19B show illustrative state transition diagrams according to certain non-limiting example embodiments;

FIG. 20 is a block diagram of a non-limiting system including a charging node according to certain example embodiments; and

FIG. 21 is a graph of call data.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in a non-transitory computer readable medium and so executed by a computer or processor, whether or not such computer or processor is explicitly shown.

The functions of the various elements including functional blocks, including but not limited to those labeled or described as “computer”, “processor” or “controller” may be provided through the use of hardware such as circuit hardware and/or hardware capable of executing software in the form of coded instructions stored on computer readable medium. Thus, such functions and illustrated functional blocks are to be understood as being hardware-implemented and/or computer-implemented, (e.g., machine-implemented).

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions.

In terms of computer implementation, a computer is generally understood to comprise one or more processors, or one or more controllers, and the terms computer and processor and controller may be employed interchangeably herein. When provided by a computer, processor, or controller, the functions may be provided by a single dedicated computer, processor, or controller, by a single shared computer, processor, or controller, or by a plurality of individual computers, processors, or controllers, some of which may be shared or distributed. Moreover, use of the term “processor” or “controller” shall also be construed to refer to other hardware capable of performing such functions and/or executing software, such as the example hardware recited above.

The technology may be used in any type of cellular radio communications (e.g., GSM, CDMA, 3G, 4G, etc). For ease of description, the term user equipment (UE) encompasses any kind of radio communications terminal/device, mobile station (MS), PDAs, cell phones, laptops, etc.

Referring now more particularly to the drawings in which like reference numerals indicate like parts throughout the several views.

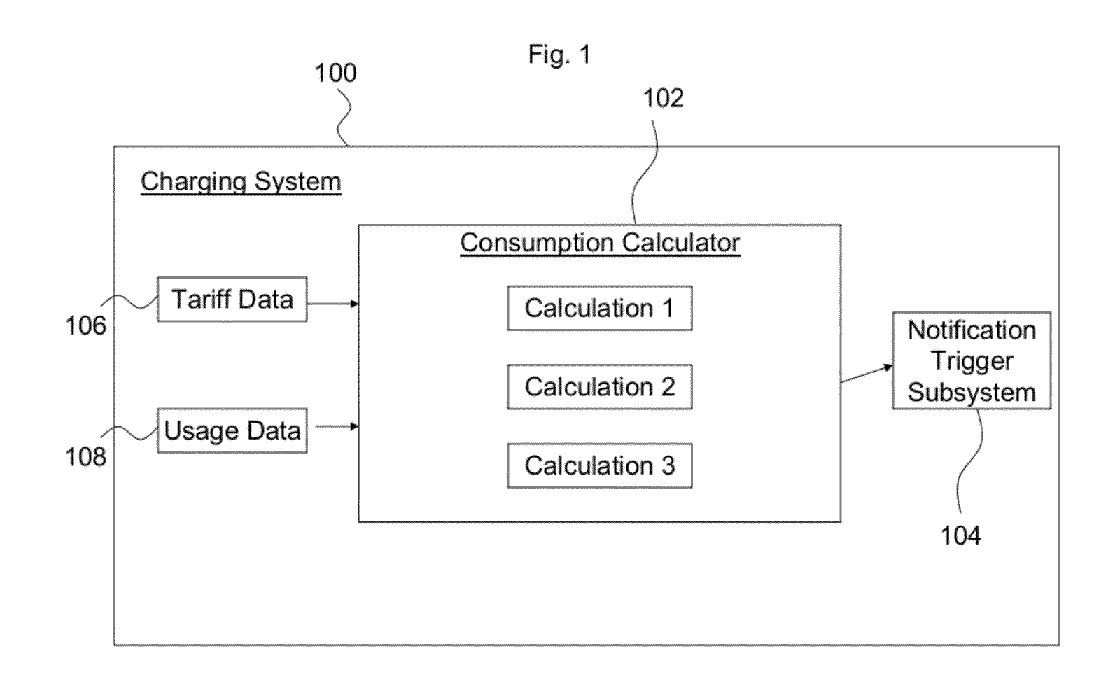

FIG. 1 is a block diagram of a non-limiting charging system according to certain example embodiments. A charging system 100 may include a consumption calculator 102 that is used to calculate different consumption related values. The consumption calculator may accept tariff data 106 (e.g., price per unit, such as one dollar per megabyte) and usage data 108 (e.g., consumption data, such as a user has consumed five megabytes of data) as input. It will be appreciated that other types of data may used by the consumption calculator 102. Other types of data may include, for example, the current location of the UE connected to an associated mobile network, usage data on other UE's related to a primary UE (e.g., as part of a family plan), the time of day, the duration of a give call or calls, or other data related to a subscriber's (other the subscriber's UE) interaction with a service provider or mobile communications network.

When the consumption calculator 102 receives/retrieves tariff data 106 and usage data 108, one or more calculations may be performed. Consumption calculator 102 may include calculations 1, 2, and 3 that are different types of calculations that use the tariff data and/or usage data. Example calculations according to certain example embodiments are explained in greater details below. Also, as explained in greater detail below, the calculations may be combined to form yet further calculations (e.g., Calculation 1 AND Calculation 2).

Based on calculations 1, 2, and/or 3 the consumption calculator may communicate with a notification trigger subsystem that may operate to determine what notifications to send, where to send the notifications, to assist in the creation of the notifications, etc. The notifications trigger subsystem 104 may then facilitate communication with a target UE.

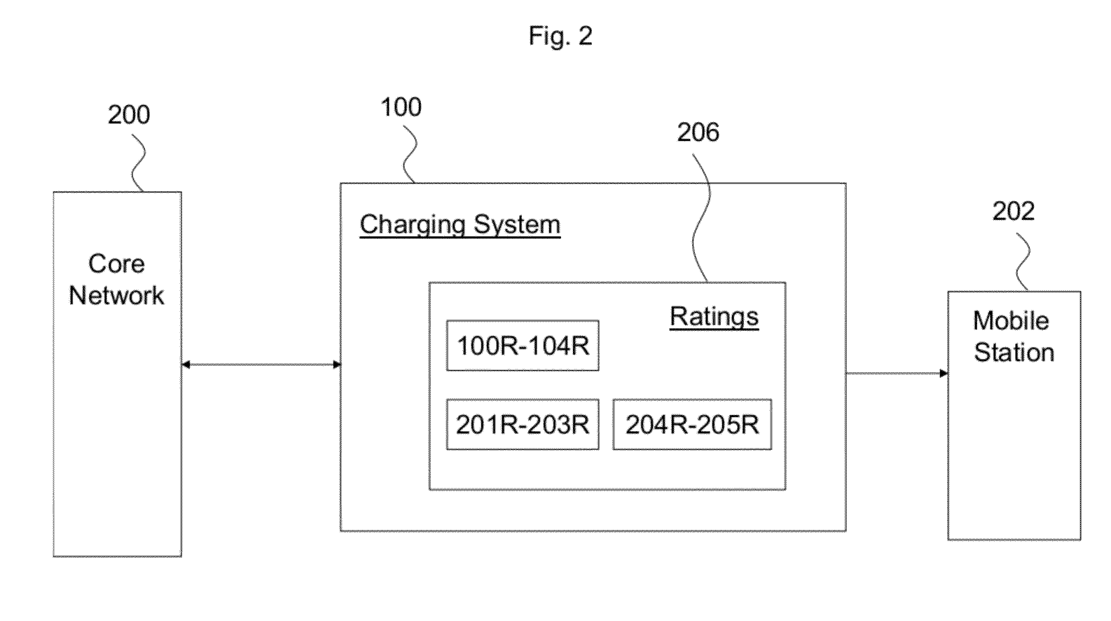

The charging system may operate in conjunction with, or a part of, of a mobile communications network. FIG. 2 is a block diagram showing a non-limiting charging system in an example mobile communications network. The charging system 100 may communicate with a core network 200 of a service provider that operates a communications network. The core network 200 may provide data to the charging system 100 (e.g., usage data). From the data received the charging system 100 may calculate various ratings (e.g., 100R-104R, 201R-203R, and/or 204R-205R) that may be related to a particular type of notification. Based on the calculations and/or the ratings calculated therefrom, the charging system 100 may cause a notification to be sent to a mobile station 202 (e.g., through the notification subsystem 104). In certain example embodiments, the mobile station 202 may include a filter or suppression service (described in greater detail below) that filters or suppressed certain triggered notifications based on a predetermined or dynamic process. In certain example embodiments the suppression or filtering service may be provided in other parts of the mobile communications network (e.g., within the charging system 100 or core network 200).

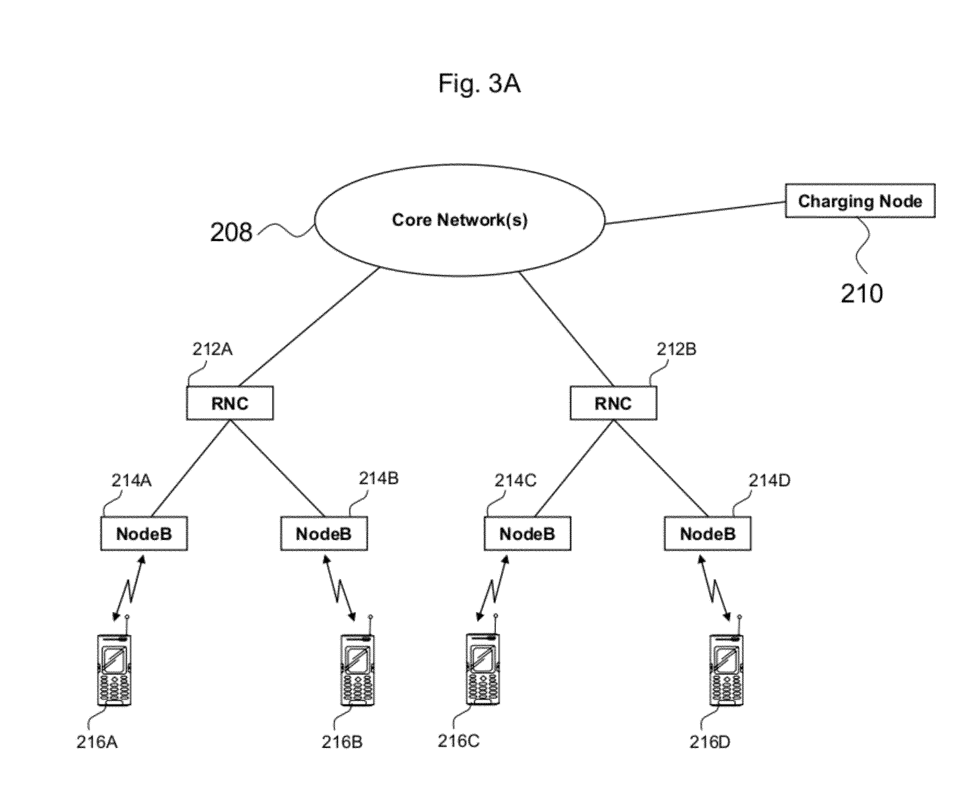

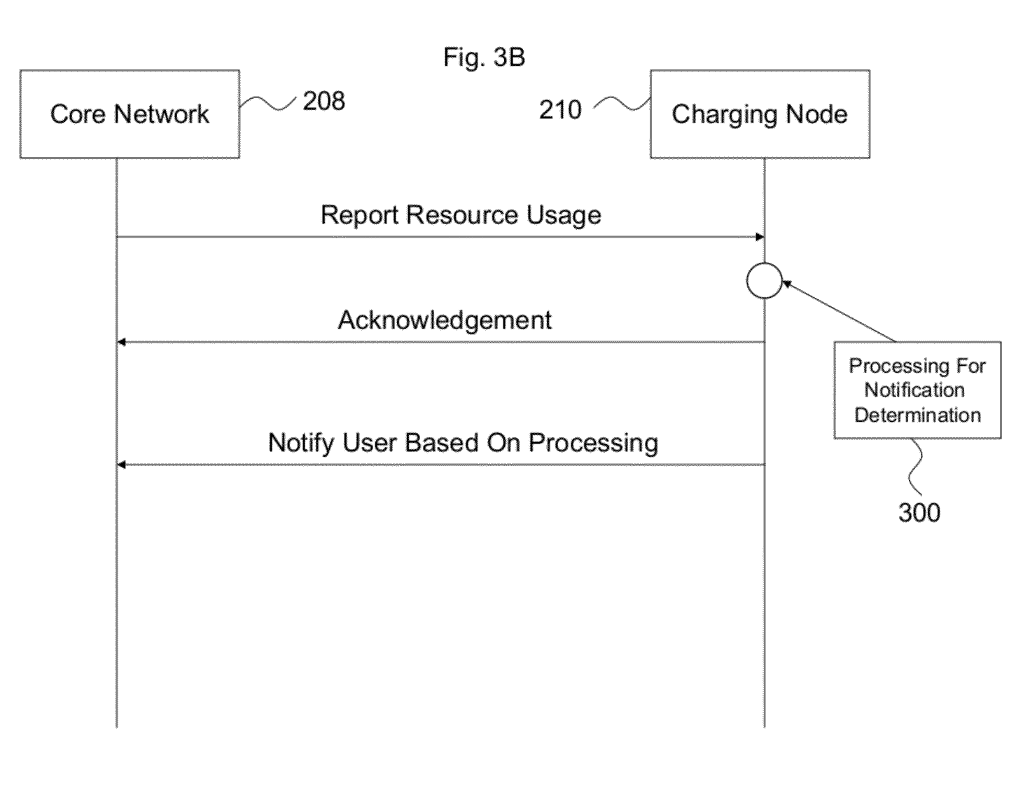

FIG. 3A is a non-limiting diagram of a network operator servicing respective subscribes with an exemplary charging node. A communications network includes a core network 208 and a RAN (e.g., a UTRAN) that includes RNCs 212A and 212B and NodeBs 214A, 214B, 214C, and 214D.

Core network 208 provides various core functionalities for a communications network of a service provider. It will be appreciated that core network 208 may include numerous separate core networks that may interface with each other. The core network 208 may provide various services. Such services may include, for example: 1) an authentication capability to determine whether a UE requesting a service from the communication network is authorized to do so; 2) a call routing or switching functionality that directs and/or determines how calls are routed/switched within the communications network and/or other networks; 3) communication between nodes of the core network 208 and/or RAN layer; and 4) statistic gathering capability such as, for example, the number of calls being handled, the number of subscribers attached to the network, the type of services being used, or the like.

Base stations 214A, 214B, 214C, and 214D (e.g., NodeBs) facilitate mobile radio communications for a network operator of core network 208 to UEs 216A, 216B, 216C, and 216D that are subscribed to the network operator's mobile network. The individual UEs may obtain service through a base station that facilitates mobile communications service with a given geographical area. Thus, UE 216A obtains service (e.g., over allocated radio resources through techniques such as TDM or FDM) through base station 214A; UE 216B obtains service through base station 214B; UE 216C obtains service through base station 214C; UE 216D obtains service through base station 214D.

It will be appreciated that the example network architecture of FIG. 3A is shown only be way of example. Other types of network implementations may be used in accordance with certain example embodiments. For example, RNC nodes 212A/B may be removed and the NodeBs may communicate directly with the core network 208. Certain example embodiments may be implemented in conjunction with GSM, CDMA, 3G, 4G, IP based systems, etc.

In certain example embodiments, the core network 208 may communicate with a charging node 210 to facilitate notification delivery (e.g., when to send a notification and/or where to send a notification). In certain example embodiments, the charging node may be a node within the core network.

FIG. 3B is a signal diagram illustrating exemplary signals between a core network and a charging system. The core network 208 may communicate with the charging node 210 by sending a report on resource usage. The report on resource usage may be related to the resources that have reserved for a particular UE, user account, or the like. The report resource usage signal may be triggered by the consumption of the reserved resources by the UE. Alternatively, a reservation of resources may be tied to a specific period of time (e.g., a reservation may have a time-to-live value associated with it). Thus, when the period of time expires, the report resource usage command may be triggered. Other types of triggers may be implemented, for example, the report resource usage may be triggered at regular intervals that are not specifically tied to the expiration of a reservation. In any event, resources usage may be reported to the charging node 210. Based on this usage data, the charging node may perform notification determination processing 300. In addition, after receiving the resource usage data the charging node 210 may acknowledge the receipt of the report to the core network 208. Furthermore, based on the notification determination processing 300, the charging node 210 may communicate to the core network to cause a notification to be sent to a UE.

In certain example embodiments, usage is monitored on a per device level. For example, UE 216A is monitored by the core network 208 and the core network 208 reports usage of network resources to the charging node 210. Based on this information, notifications may be triggered that are then sent to the same UE being monitored, UE 216A. In certain example embodiments, the core network and/or the charging node may aggregate the usage of multiple UEs. For example, UEs 216A and 216B may acquire service from the service provider under the same service plan. Thus, the core network may communicate the usage data of both UE 216A and UE 216B to the charging node. Based on the combined usage data, notifications may then be sent to one or all of the UEs associated with the service plan. For example, a notification may be configured to be sent to the “primary” UE associated with the service plan (e.g., the head of household for a family plan). Alternatively, notifications may be sent to all, or a subset, of the UEs under the service plan. In certain example embodiments, the usage of one UE may be monitored and notifications may be sent to another UE based on the monitored usage. For example, UE 216A may consume a large amount of data over a short period of time. Core network 208 may report this usage to the charging node 210. The charging node 210 may perform calculations based on the reported usage, and then determine that a notification should be triggered. An option may be sent to send all notifications related to UE 216A to UE 216B. Alternatively, or in addition, the type of triggered notification may determine the destination (e.g., a UE) of the notification. In certain example embodiments, multiple different UE's may be assigned to multiple different types of notifications. For example, a triggered decrease notification may be sent to 216A; a triggered increase notification may be sent to UE 216B; and/or a triggered continue notification may be sent to UE 216C. It will be appreciated that other embodiments may be implemented in determining where and/or how notifications may be sent to various UEs.

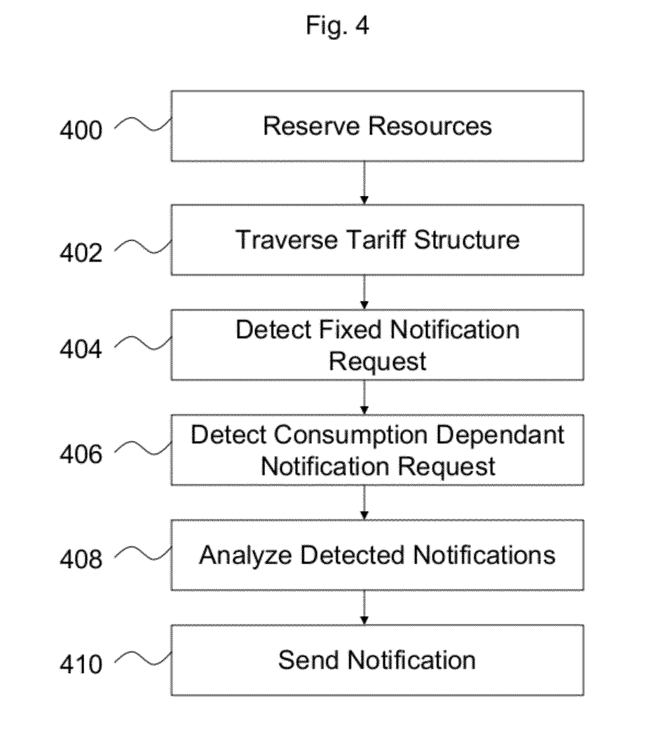

FIG. 4 is a flow chart showing an example notification procedure according to certain example embodiments. At the start of a charging session (e.g., when a user places a telephone call from a UE), resources are reserved in a charging system in step 400. The reservation request may act to reserve resource that can be money, megabytes (MB), seconds, or other types of units. In certain example embodiments, the resources are paid for in advance by the user, or within the credit limit of the user. Accordingly, the reservation grants the user the resources to “spend.” In certain example embodiments, this process may not require any further interrogation with respect to a charging system.

Next, the reservation process may include a check in the charging system. This check may cause a traversal to be performed through a tariff structure in step 402. The output from this check may be related to the cost per resource. Next, in step 404, fixed notifications related to account thresholds, account limits, rate, and/or discounts may be checked. After checking for fixed notifications, consumption dependant notifications may be checked in step 406. In certain example embodiments, the output from the consumption dependent check may be a measurement related to resources consumed over time. After the above notification steps, the triggered/detected notifications may be analyzed in step 408. The analysis may include an evaluation of output from the consumption dependant notification check, suppression of low consumption values, and/or commands to send notifications related to high consumption values. When a command to send a notification is triggered the notification (e.g., the notification message) is sent in step 410.

In certain example embodiments, one or more of the above steps may be omitted depending on design or other considerations. For example, step 404, may be omitted if fixed notifications are not to be detected.

In certain example embodiments, notifications may depend on the cost rate (resource usage) of a service over time. The cost rate may depend on the price plan and/or discount of a service but may also depend on the “intensity” of certain chargeable parameters due to usage behavior.

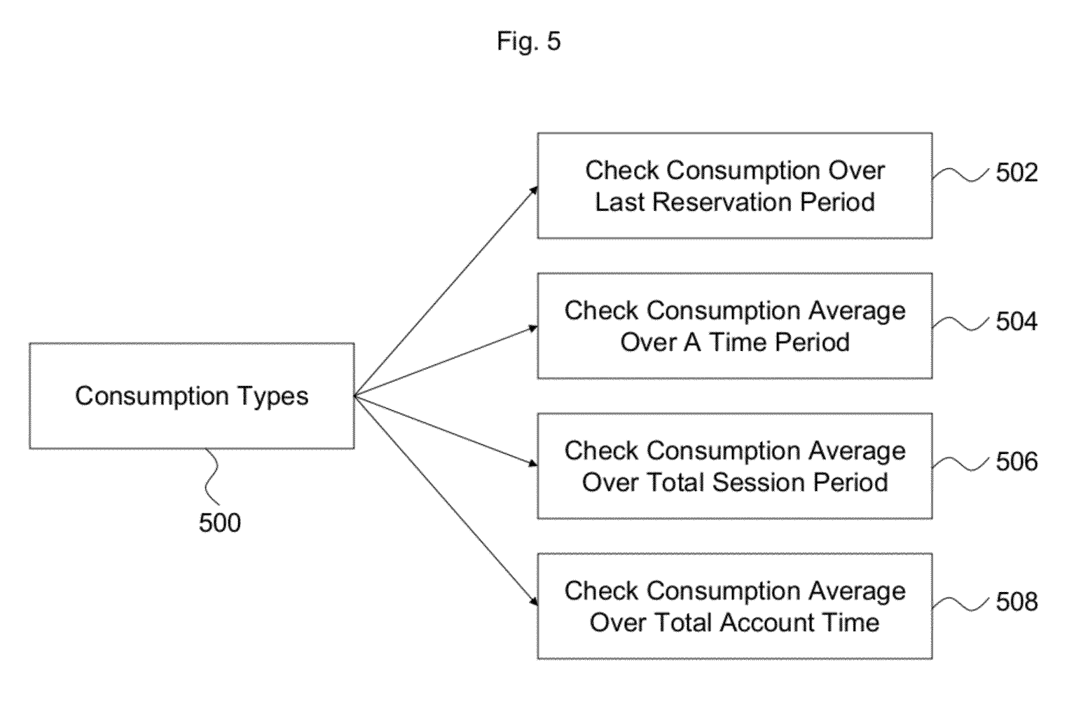

As noted above, there may be multiple different types of calculations for detecting consumption dependent notification requests. FIG. 5 is a block diagram showing exemplary consumption types used in certain example embodiments. Consumption types 500 for detecting consumption dependent notification may include multiple different types of calculations relating to the consumption of resources over some period of time.

Check consumption over last reservation period 502 uses input from a report resource usage report (e.g., the latest report) and may return a resulting value (e.g., consumed resource/consumption report time). This method may check how fast a given reservation was consumed. The output may be dependant on reservation amount (e.g., 5 MB vs. 500 MB) and allowed reservation times. In certain example embodiments, using this type of consumption check may facilitate detection of fast and/or drastic changes in usage rates. For example, consumption of 2 megabytes over a 4 second reservation may indicate a drastic change in the consumption of resources and trigger an associated notification.

Check consumption average over predefined time 504 uses input from a specified number of report resource usage reports that fit in the predefined time frame. Alternatively, in certain example embodiments, the time frame may be dynamically determined. In certain example embodiments, a sliding average is calculated for the time frame time (explained in more detail below). In certain example embodiments, this check may detect changes that impact ongoing sessions. For example, a virus program may start to download data without user's knowledge. Further, this consumption check may facilitate notifications that alert a user to the possibility of postponing a transfer until a later or cheaper period.

Check consumption average over total session time 506 uses input from all resource usage reports over a given session. Accordingly, an average is calculated for the session. This check may detect long term high consumption. For example, the session average may show that operating at this rate correspond to a user spending $20 or more per 24 hours in an ongoing session.

Check consumption average over total account time 508 uses input from all resource usage reports for all sessions and services and a predefined time. Thus, an average is calculated for the account. This check may detect long term high consumption per account. For example, an account average that shows at a calculated rate the user will spend $20 or more per 24 hours including all services.

In certain example embodiments, a calculated average can be weighted so that older data points may not influence the resulting calculation as much as more recently acquired values. For example, in the case of interrogation based averages, a discrete weighting scheme can be applied. In the case of a session or time based average, either a continuous weighting function can be applied or a discrete function can be applied (e.g., if the session or time span is discretized first). In certain example embodiments, the weight may be arithmetically decreasing, exponentially decreasing, or a variation of some other calculation.

Furthermore, as explained below, the consumption checks of FIG. 5 may be combined to form yet further types of consumption checks. Additionally, other types of consumption checks may be included according to certain example embodiments.

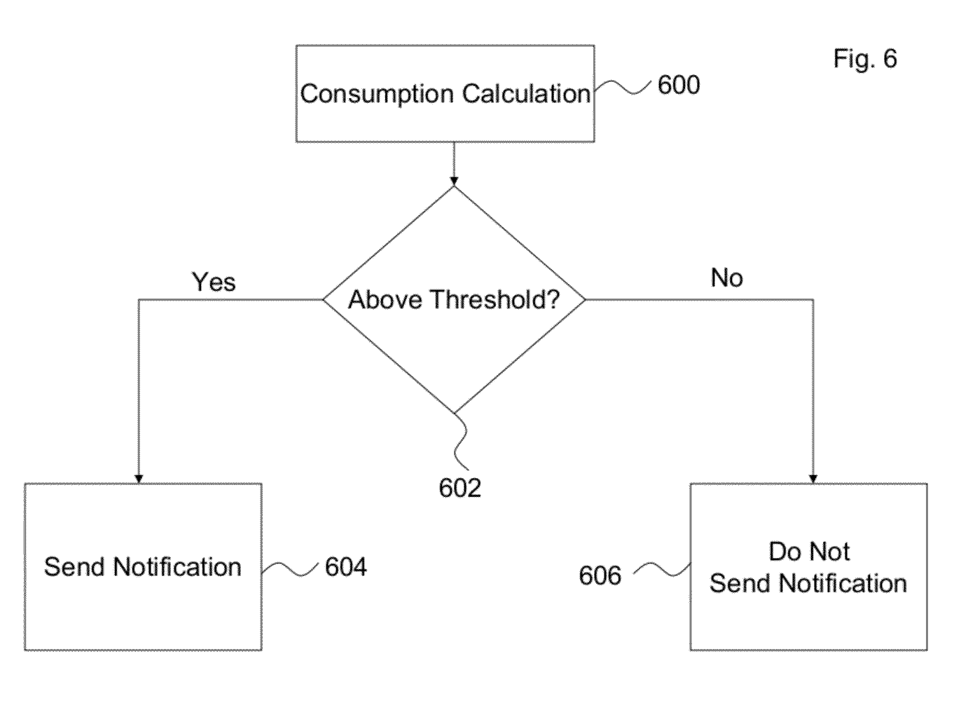

FIG. 6 is a flow chart showing an illustrative procedure for sending a notification. Certain example embodiments may include checking a consumption value and comparing the calculated value to a predetermined or dynamic threshold value. In step 600, a consumption calculation is made. The consumption calculation may, for example, include any or all of the consumption types shown in FIG. 5.

In one example embodiment the following consumption checks may be performed: 1) 502 AND 504; 2) 504 AND 506; 3) 506 AND 508; 4) 508 AND 502 (where “AND” is a Boolean operator). Each of these example calculations may be compared to a threshold value in step 602. Thus, for example, the calculation related to 502 and the calculation related to 504 may each be compared to respective thresholds. Based on the threshold determination in step 602, a decision may be made to send a notification in step 604 or not to send a notification in step 606. In certain example embodiments, a threshold determination may be successful if either of the calculations is above a threshold (e.g., an OR Boolean operator). Certain example embodiments may use other types of logic to combine calculations (e.g., XOR).

As shown above, multiple different threshold calculations may be performed. Accordingly, in certain example embodiments, the order of the different calculations may be adjusted. Different orderings may function to prioritize the multiple threshold determinations. For example, if the first option is successful and sends a message, the next three determinations may be skipped. Accordingly, different notifications tied to different types of threshold calculations may be ignored. This may allow only “important” notification to be sent out rather than notifications that are not important. Alternatively, the next determination may be performed and the associated notification sent out. In certain example embodiments, the threshold determinations may be stored for later triggering. In certain example embodiments, the priority of the threshold determinations may be configured by a user and/or an administrator. For example, a user may setup different types of notifications based on individual preferences. Alternatively, or in addition, an administrator (e.g., of a service operator) may determine the priority of threshold determinations.

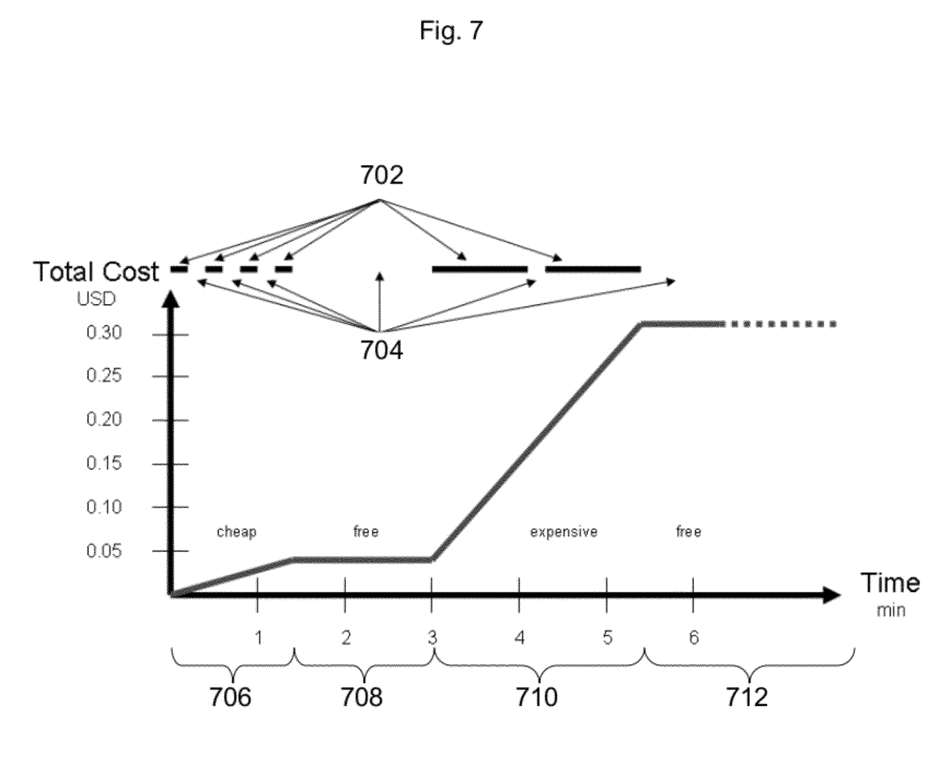

Certain example embodiments may perform consumption calculations based on active/passive service. FIG. 7 is an illustrative graph showing example call data according to certain example embodiments. Segments 702 indicate sections of a mobile connection that are “active.” Segments 704 indicate sections of a mobile connection that are “passive.” Section 708, shows a portion of the call (or data connection) that is free. This corresponds to the relatively low consumption rate because of the large empty spot in the middle of segments 704. In contrast, section 710 (corresponding to the long segments of 702) may be calculated to be more expensive because of the increased usage. Accordingly, based on the consumption (where consumption is talking), the service may have a normal cost for section 706, free in section 708, expensive in section 710, and free again in section 712. In one example, a user may download a particular article to read. The downloading of the article may be seen as the “active” portion of the service. In contrast, the passive portion may be after the article is downloaded and the user is only viewing the article (e.g., there is no background downloading continuing). Accordingly, the active and passive periods of use may vary as a user “flips” through the pages of an e-newspaper or the like.

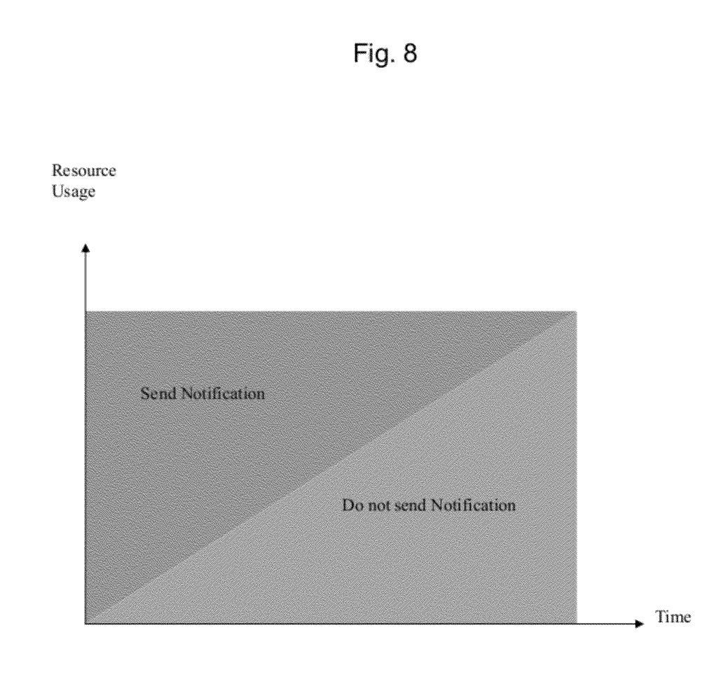

As discussed herein, a notification may be related to a calculated consumption rate (e.g., as shown in FIG. 7 or related to consumption types in FIG. 5). FIG. 8 is an illustrative graph showing notification conditions according to certain example embodiments. Here, resource usage is plotted against time to determine when a notification should be sent. While FIG. 8 shows a linear graph of consumption usage, other types of graphs may illustrate the determination of when a notification should and should not be sent. For example, the calculation of a consumption rate may be based on an exponential function (or the inverse thereof) or other types of non-linear functions.

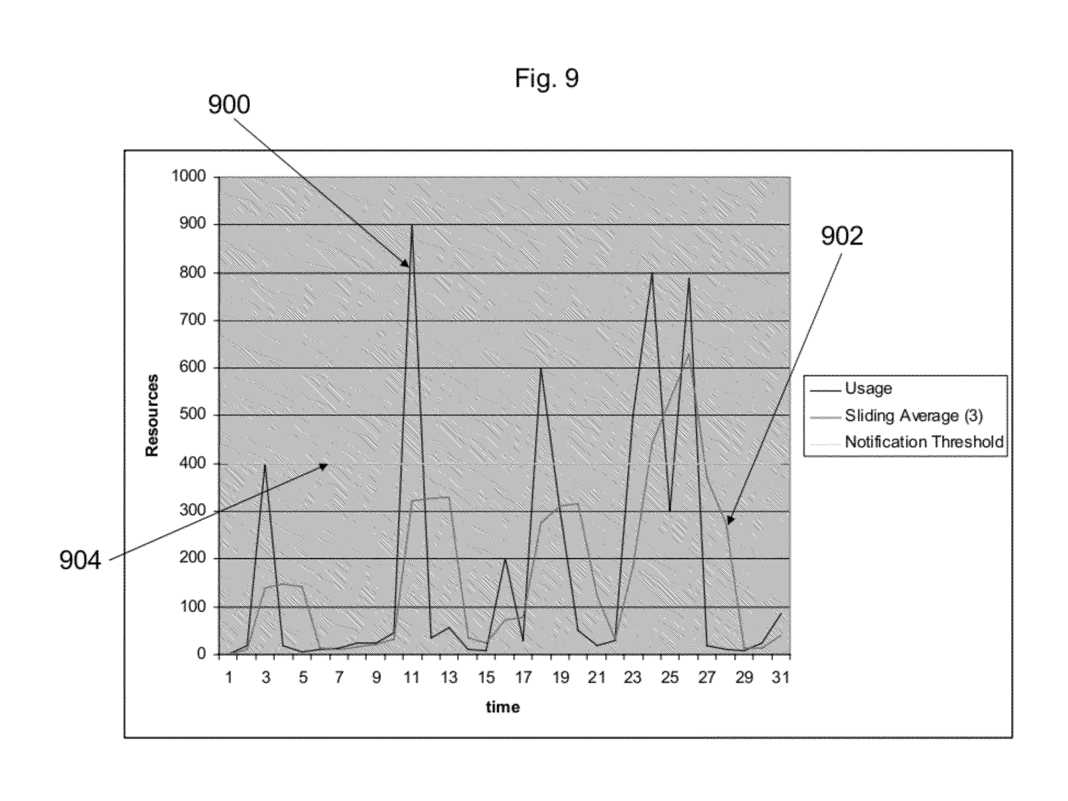

As noted above, usage rates may be based on a usage/time calculation. FIG. 9 is another illustrative graph showing example call data and associated calculations used in certain example embodiments. In FIG. 9, measured usage of a UE is shown by line 900. A threshold which is used to trigger a notification is shown by line 904. As shown, the usage varies between 900 resources consumed at time 11 and close to zero resources consumed at time 7. Furthermore, this change exceeds the threshold level at 400 resources. However, a small spike in usage may give, for example, too many false positives in triggering a notification. Accordingly, line 902 shows a calculation over a sliding average (or moving average). The sliding average is calculated with respect to three usage data points. As can be seen, when a sliding average is used the spike in usage at time 11 is averaged out, resulting in no notification being triggered.

As discussed herein, notifications may depend on a calculated utilization rate. In certain example embodiments, the utilization rate may also be based on the price of the service (e.g., the tariff rate or price per unit consumed). This information may assist a user in using (or planning) the use of resources of a mobile service provider. It may also help a service provider to better manage network resources.

In certain example embodiments, the rate may be used to determine transitions between high/low cost and/or high/low utilization. Thus, a change in rating (e.g., a calculated consumption or the like) that is a significant change in cost rate for the user may trigger a notification with a message informing the user of the changed conditions with a recommended course of action. Certain example embodiments may include different types of actions. Each of the actions may have different sub-actions. The sub-actions may be related to how transitions between two or more calculated consumptions are analyzed. Below are example actions that may be used according to certain example embodiments.

Action 1: “Decrease” (At high usage at high prices)
Decrease, the price has increased
Decrease, the volume has increased

Action 2: “Wait” (At low usage at high prices)
Wait, the price has increased
Wait, the volume has decreased (suppressible)

Action 3: “Increase” (At low usage at low prices)
Increase, the price has decreased
Increase, the volume has decreased

Action 4: “Continue” (At high usage at low prices)
Continue, the price has decreased
Continue, the volume has increased (suppressible)

Certain notifications may be suppressible depending upon the changed property. For example, the “continue” message may be sent when the price has decreased and the volume remains the same. However, an increase in volume combined with the same or similar price may result in a notification system suppressing (e.g., not triggering) the “continue” notification.

Usage may include different types of usage. For example usage can be volume in a mobile network data session, length of a phone call, or other usages, such as usages in a congestion pricing network (e.g., electricity usage—if rated in a charging system). Cost rates according to certain example embodiments may depend on the price of a service and the usage of the service for a specific time period. For example, if the price for downloading data is $3 per megabyte downloaded and the user consumed 5 megabytes in 10 minutes the cost rate may be calculated to be $1.5 per minute. Accordingly, notifications may be triggered based on context aware thresholds that are related to resource utilization over a sampling interval (e.g., a reservation period, session period, etc).

### State-Based Example Embodiments

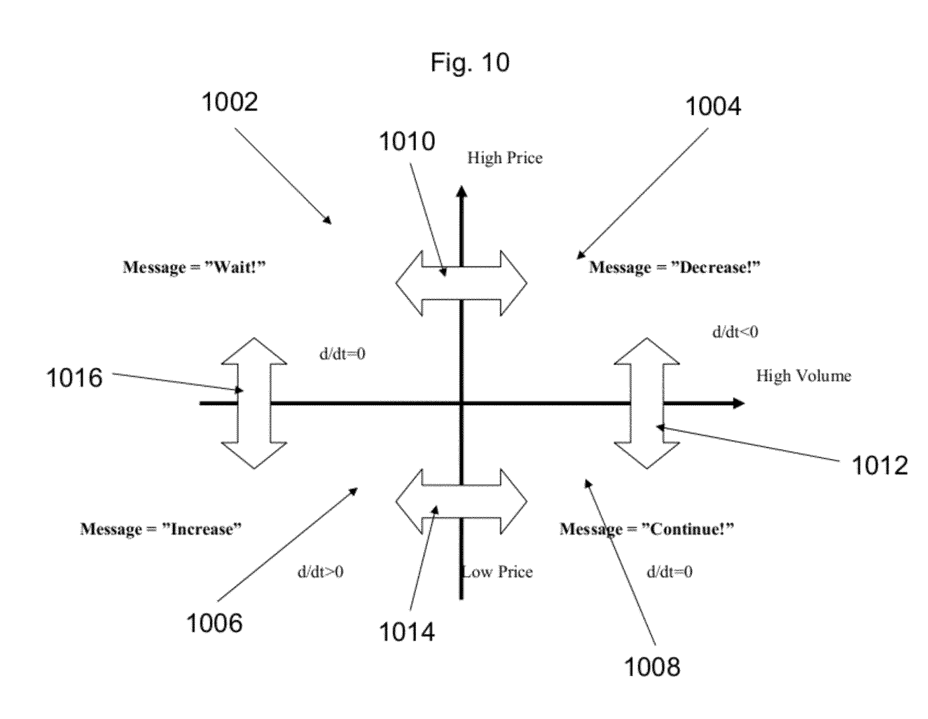

FIG. 10 is an illustrative chart showing example notifications states with associated notifications that may be sent to a user. Here, the notification states are related to a position on a volume vs. price graph. Thus, state 1002 may include consumption that has a high price but low consumption. State 1004 may include consumption calculations that include both a high price and high consumption. State 1006 may include consumption calculations that relate to low prices and low consumption. State 1008 may include consumption calculations that relate to low price and high consumption. Further, the various states may be associated with notification messages that may be triggered when a consumption value is calculated that falls within the given state. Alternatively, or in addition, notifications may be based on the transition between states. Accordingly, a consumption calculation that falls within state 1002 may trigger a notification message of “Wait.” Accordingly, transitions 1010, 1012, 1014, and 1016 may determine (or partially determine) which notifications are sent to a user.

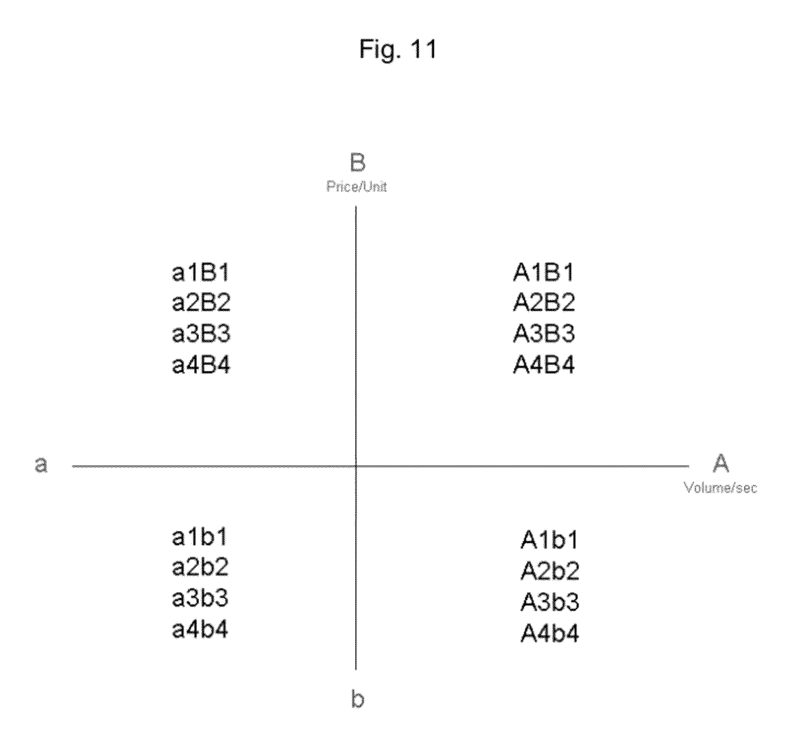

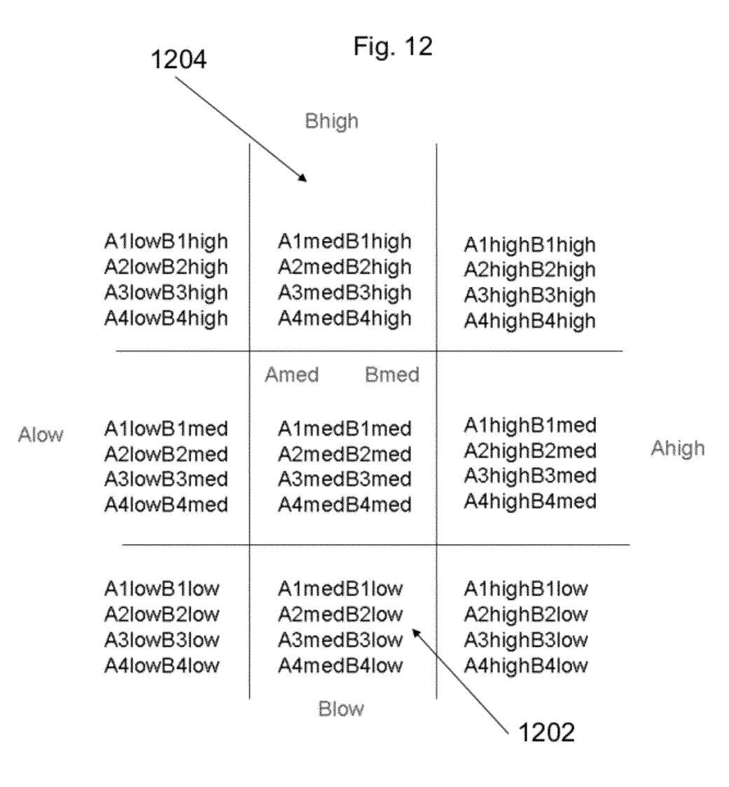

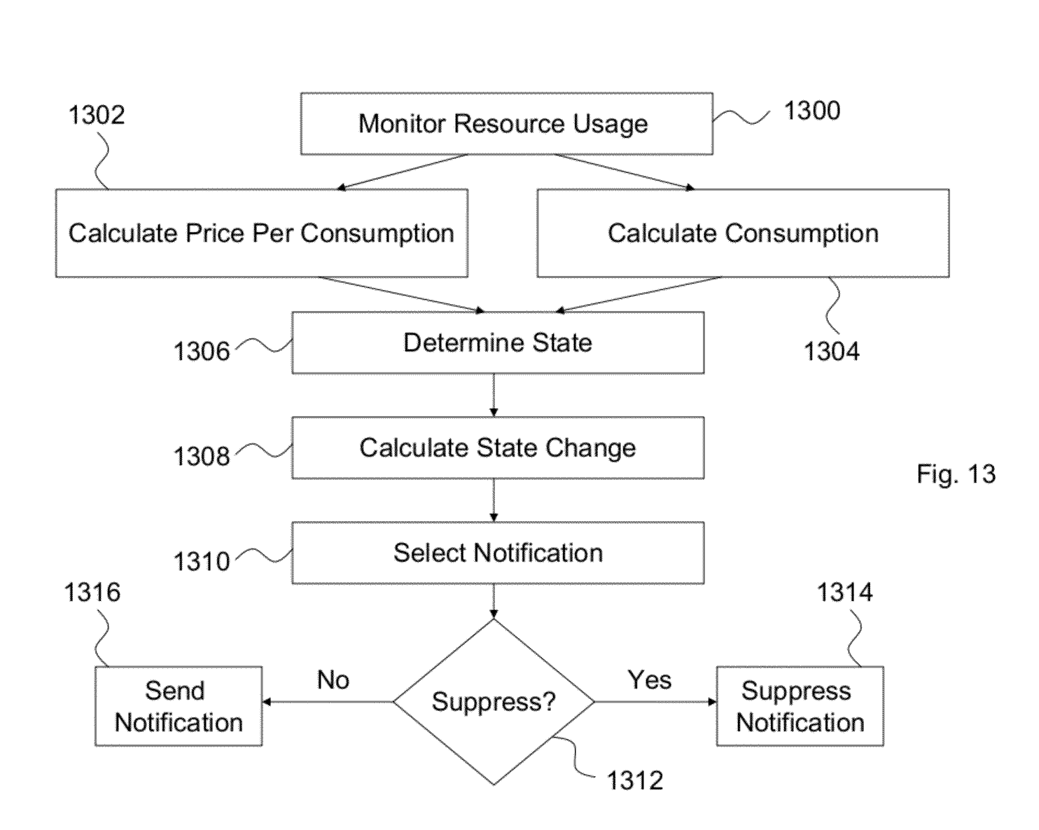

FIGS. 11 and 12 are illustrative charts showing example notification states according to certain example embodiments. FIG. 11 shows an illustrative chart with four states. FIG. 12 shows another illustrative chart with nine example states. FIG. 13 is a flow chart showing a non-limiting state-based notification procedure. This non-limiting state-based procedure may be related to the state charts shown in FIGS. 11 and 12.

As discussed herein, resource usage by a UE, account, or other element may be monitored by a charging system and/or other functionality within the core network of a mobile network. Accordingly, in step 1300 of FIG. 13 resource usage is monitored for a UE. Next, the price per consumption (e.g., the cost of a resource) and the amount of consumption over a given time period are calculated in steps 1302 and 1304, respectively. The consumption calculations may include multiple different types of consumption calculations. Different methods of calculation for consumption values may include: A1) Last reservation period (short time perspective); A2) Average over predefined time (sliding average, avoiding bursts); A3) Average over total session (long time perspective); A4) Average over total account time (historical perspective). In certain example embodiments, the results of a given consumption calculation may have 2 or more “levels.” For example, the two levels may be, a=low and A=high. FIG. 11 shows the above “A” values 1 through 4 with upper and lower case versions. The lower case version may correspond to lower calculated consumption values and the upper case version may correspond to higher calculated consumption values. The above example calculations may be used individually or in combination with each other or other calculations. Further, certain example embodiments may have more than the above exemplary two levels. For example, FIG. 12 shows three levels of consumption calculations that include low, medium, and high values. Further embodiments may include even more levels.

Based on the calculated price and consumption in steps 1302 and 1304, a state may be determined in step 1306. In other words, the individual methods e.g., 1-4 for A and B discussed above may be individually compared. Thus, the combination of A and B may decide the currently classified state. For example, in FIG. 12, a calculated consumption may be A2med and the price per consumption may be B3low. This combination of levels may result in a determined state 1202. After determining the current state, in step 1308 a state change is calculated. Here, the current state table (e.g., from step 1306) is compared with previous state table (e.g., a table calculated in a prior iteration) to determine a state change. In certain example embodiments, the determined state change may then be stored with information on the new state and the old state. The result may indicate the degree of state change. For example, a change in state between state 1202 and state 1204 in FIG. 12 may result in a state change of 2.

In certain example embodiments, the number of individual levels for A and for B may be two. However, certain example embodiments may have more levels (e.g., 5 levels). This increased number of levels may allow a service provider greater granularity over the when notifications are sent to a user. Additionally, while the number of levels shown in FIGS. 11 and 12 are equal, certain example embodiments may include a different number of levels for each of the calculations. For example, a state table may be a 3*2, 2*3, 5*3, 4*2, 2*4, etc . . . state table.

After calculating a state change, a notification may be selected (or determined) based on the state change and level of state change in step 1310. For example, the above described messages associated with notifications may be triggered based on the current state, the prior state, and/or the degree of change between the states.

Next, the triggered notifications may be suppressed in step 1312. This may include prioritization criteria to rank notifications. Thus, notifications that are not as important may be suppressed in favor or more important notifications. Alternatively, or in addition, the triggered notification list may be compared with a message suppression list. The suppression list may include notification messages that a user does not wish to be sent to an associated UE. This list may be manually updated by the service provider and/or users. Further, in certain example embodiments the list may be dynamically generated. For example, a notification may be added to the suppression list if the particular notification has been sent to the user recently. If a notification is not suppressed, it may be passed off to the send notification step 1316 (e.g., to send a notification message). Alternatively, the message may be suppressed, and not sent, in step 1314.

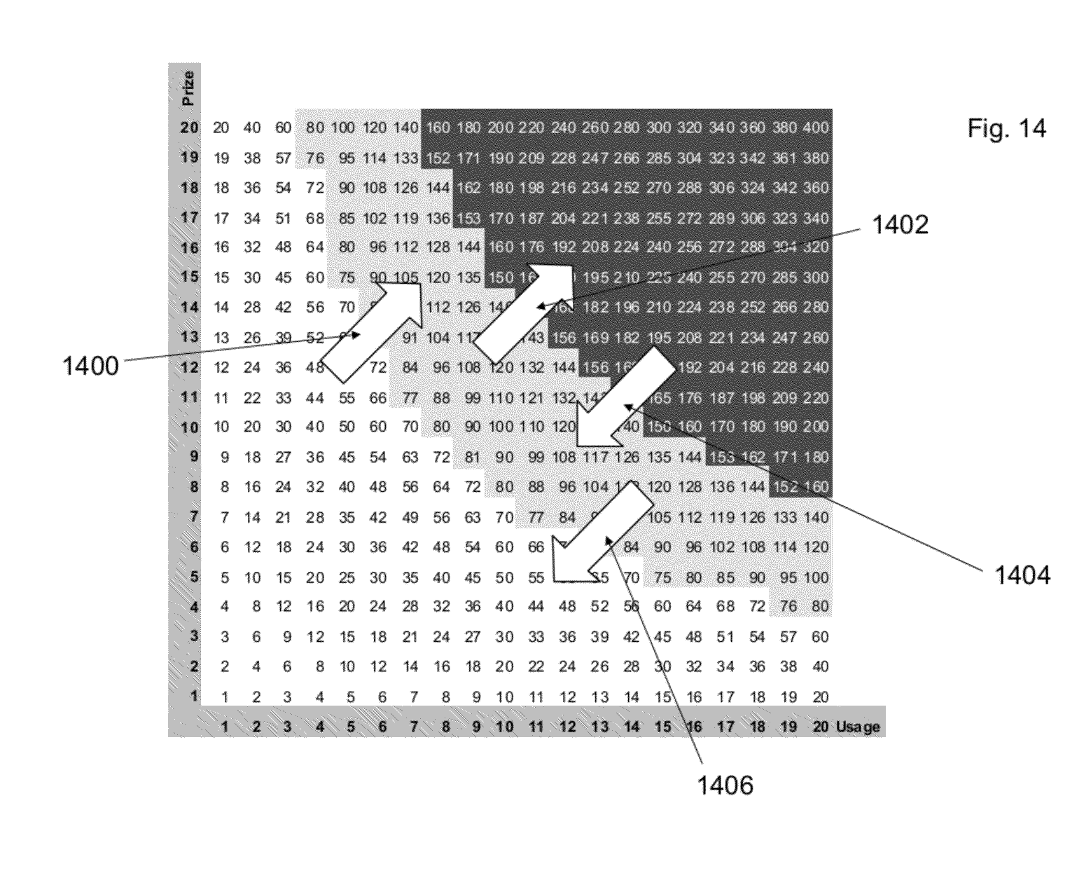

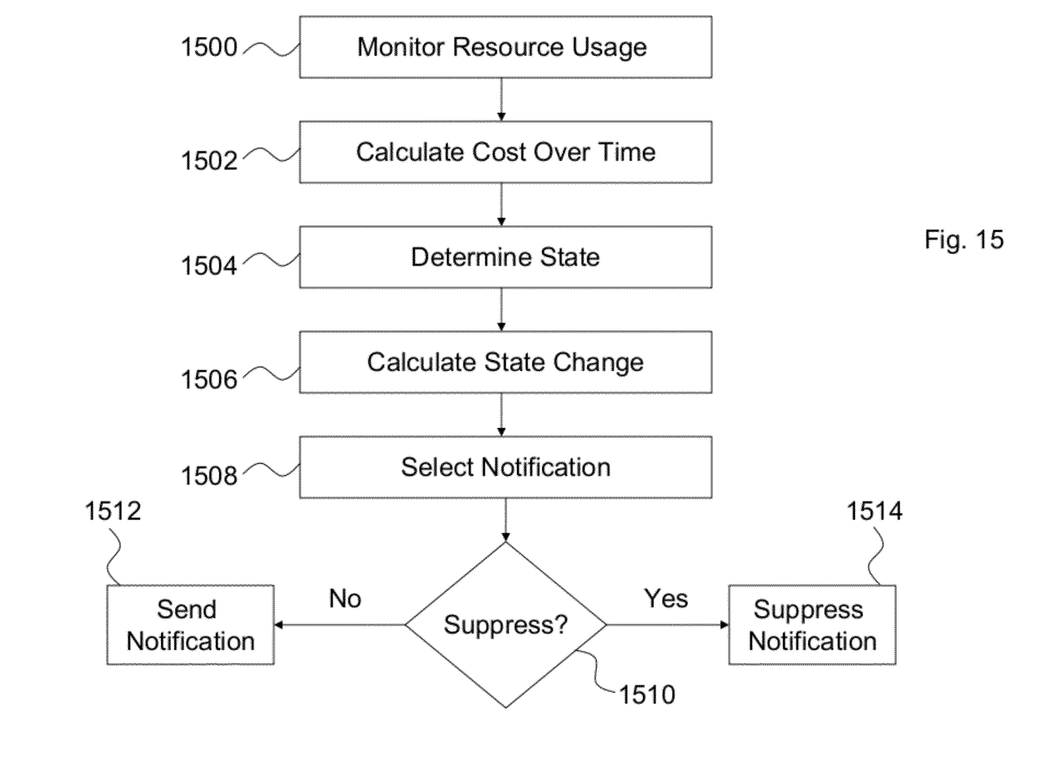

As discussed above, a state change may be determined by classifying at least two calculations in a state table. In certain example embodiments, state determinations may be made with respect to a value (e.g., the cost of resources used over time) calculated from the consumption and the price per unit. FIG. 14 is an illustrative chart showing example state transitions according to certain example embodiments. FIG. 15 is a flow chart showing another non-limiting state based notification procedure. In step 1500, resources are monitored. From the monitored resources, a cost over time for the usage of the resources is calculated in step 1502. This calculation may be done by multiplying the consumption (units) over time with the price per unit.

Certain example embodiments may include multiple different types of calculations. These calculations may include: F1) Last reservation period (short time perspective); F2) Average over predefined time (sliding average, avoiding bursts); F3) Average over total session (long time perspective; and F4) Average over total account time (historical perspective). The calculations may be used individual or in combination. Based on the above calculation, a state may be determined in step 1504. FIG. 14 shows thee different states of F_low; F_mid; and F_high. It will be appreciated that other embodiments may include a different number of states (e.g., any number, such as 10 different states).

After determining the current state, a state change may be calculated in step 1506. For example, illustrative state changes are shown as arrows 1400, 1402, 1404, and 1406 in FIG. 14. Thus, the current state may be compared with a prior calculated state to determine a state change value. The result of this determination may be stored with information about the new state, the old state, and the degree of change between the two states. Based on the state change determination a notification may be selected in step 1508. The state transitions may correspond to specific notification messages as follows: 1) state transition 1400=Continue; 2) state transition 1402=Stop!; 3) state transition 1404=Continue; 4) state transition 1406=Increase! It will be appreciated that other types of notification messages may be associated with transitions between the various states. Further, the messages may be different and include additional information as to the reason for the notification message (e.g., a numerical value).

The selected notification may be compared against a suppression list or subject to a suppression procedure in step 1510 to determine whether the notification should be sent in step 1512 or suppressed in step 1514. In certain example embodiments, the message not suppressed may then be subjected to an additional prioritization procedure that may further determine which messages are of a higher priority. Messages with lower priorities may not be sent (e.g., to avoid bombarding the customer with multiple messages) while higher priority messages are sent.

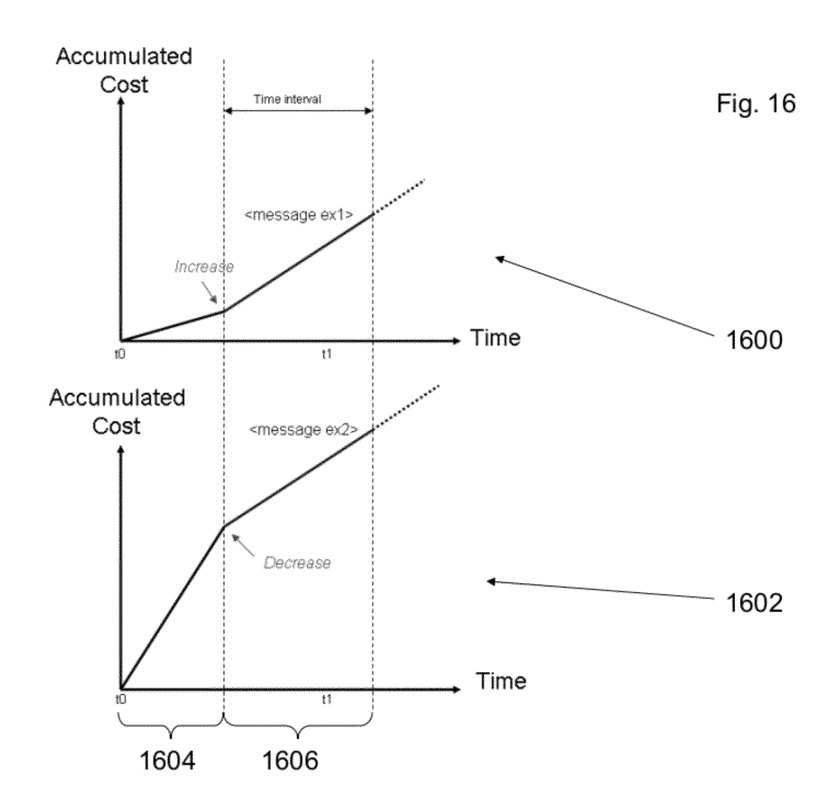

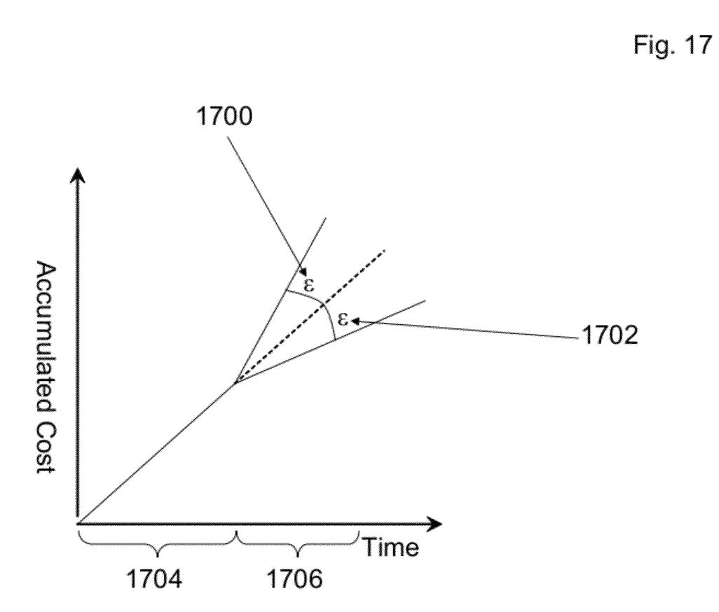

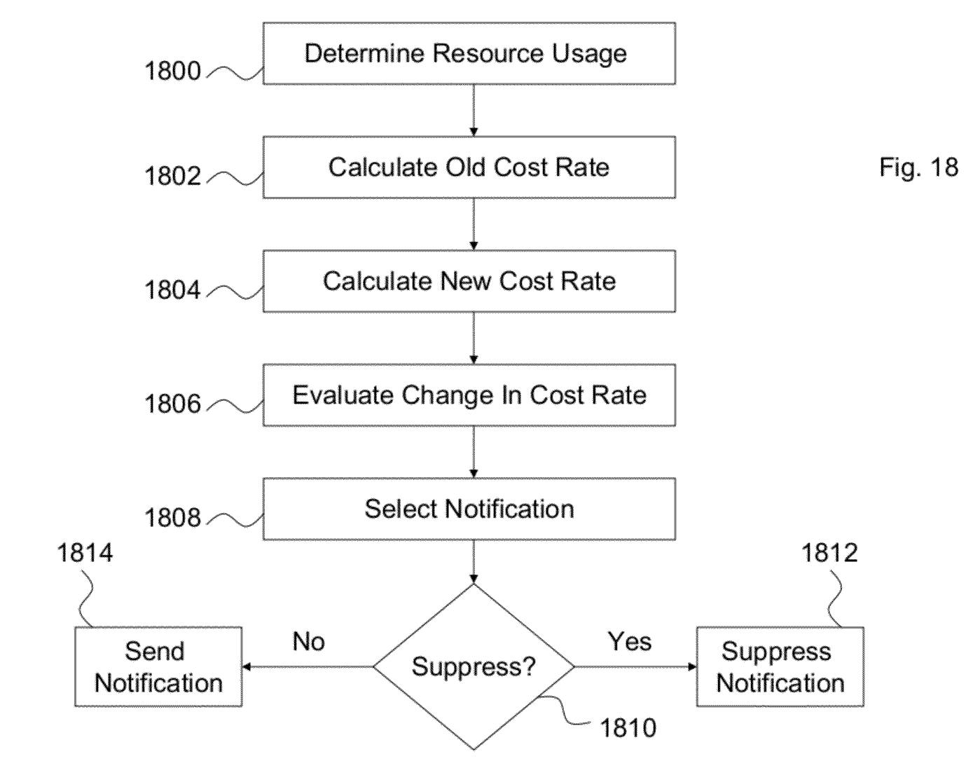

Certain example embodiments may detect cost rate changes and apply notifications based on the change in cost rate. The notifications may be suppressed if the detected change is below a certain threshold. FIG. 18 is a flow chart showing a non-limiting notification procedure where a cost rate change is related to notifications that are sent. FIGS. 16 and 17 show graphs of illustrating cost rate changes.

During a communication session the core network may report the usage of resources to a charging system in step 1800. Further, information from prior reports may be stored by the charging system. Thus, in step 1802 an old cost rate may be determined over time period 1604. In step 1804 a new cost rate may be determined over time period 1606. As with the above consumption calculations, different methods of calculating consumption or rate of consumption may be used. Some example methods may include: 1) Last reservation period (short time perspective); 2) Average over predefined time (sliding average, avoiding bursts); 3) Average over total session (long time perspective); 4) Average over total account time (historical perspective). These methods, and other illustrative methods, may be used individually or in combination.

The calculated values from steps 1802 and 1804 may be used to evaluate a change in cost rate in step 1806. FIG. 17 shows the results of an example calculation between to calculated cost rates. The first calculated rate is associated with time period 1704 and the second calculated rate is associated with time period 1706. Epsilon (ε) values 1700 and 1702 indicate different thresholds that may be used to determine if the change in cost between two time periods is large enough to trigger the sending a notification. As shown in FIG. 17, the two time periods 1704 and 1706 are associated with differently sloped cost rates. Thus, a change between these two periods may be observed as the angle of change between the slope of the rate associated with time period 1704 and the slope of the rate associated with time period 1706. The calculated angle of change between the two time periods 1704 and 1706 may then be compared against the Epsilon values 1700 and/or 1702.

FIG. 16 shows another example of change between the two calculated rates. The rates (e.g., slope) within time period 1606 in graphs 1600 and 1602 are the same. However, the rate within time 1604 is greater than in graph 1602 than the rate in graph 1600. Accordingly, even though the rate in time period 1606 is the same in both graphs, the change between the two time periods is different. This calculation may allow service providers, users, and the like, better or different control for how and when notifications are delivered.

Returning to FIG. 18, once the change in rate between the two time periods is evaluated in step 1806, a notification may be selected based on the evaluation. In certain example embodiments, the evaluated change may be compared against a threshold value. For example, a threshold value of 5 megabytes per minute change may be implemented. Thus, small changes (e.g., less than 5 megabytes) may not trigger a notification), whereas large changes may trigger the selection of a notification within step 1808. The selection of a notification within step 1808 may include a priority ordering of notification messages such that even though multiple notifications may be selected, only the notification with the highest priority may be selected for sending.

The priority ordering may be combined with suppression of notifications in step 1810. A suppression list may be maintained by the service provider such that before each notification is sent, it is first compared with a suppression list. If a notification is listed on the suppression list it may be removed or prevented from being sent in step 1812. Alternatively, the notification may be sent in step 1814.

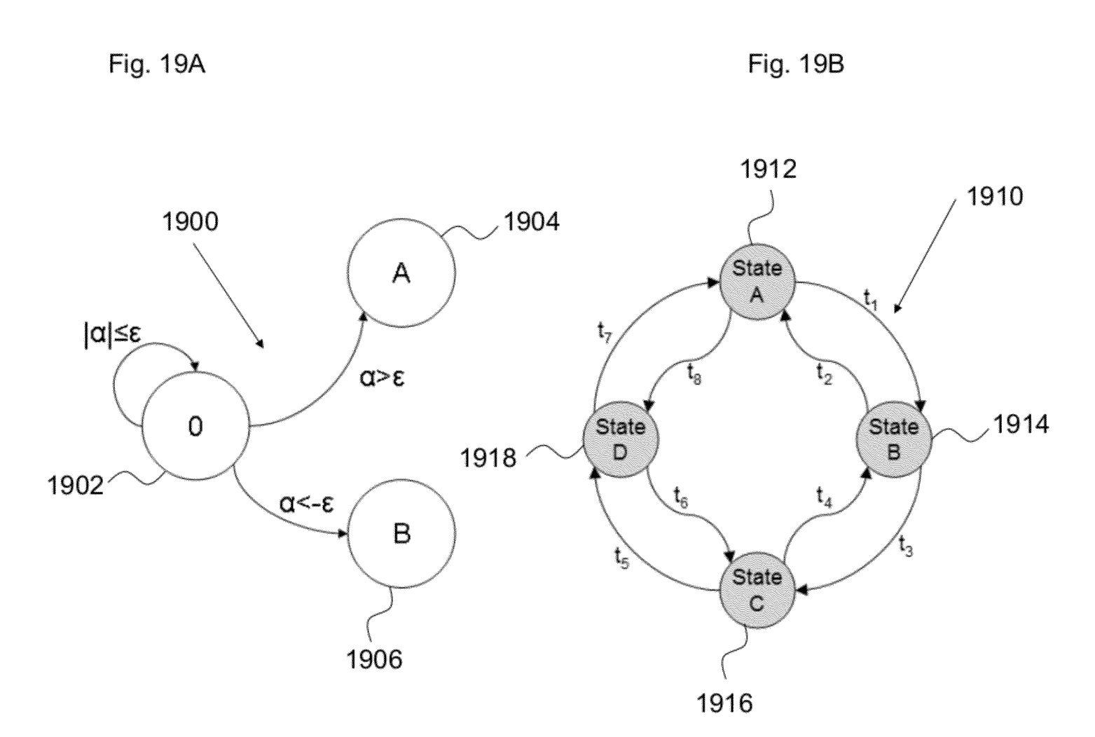

As described above, certain example embodiments may derive notifications based on state transitions between or to/from different states. FIGS. 19A and 19B shows illustrative state transitions according to certain non-limiting example embodiments. State transition diagram 1900 shows three states where state 1902 is a base state. When a calculated consumption value is above a certain threshold, ε, the state is determined to be state A 1904. In certain example embodiments, the state transition may indicate an increase in rate (e.g., a slope shown in FIG. 17). Conversely, when the rate than is less than the negative value of the threshold a different state transition may occur to state B 1906. If the calculated consumption value is between the negative and positive thresholds (e.g., if the absolute value of the change is less than the threshold) then the state machine may remain at state 0 1902. In certain example embodiments, the calculated consumption value may be represented as an angle of change (described in more detail above).

FIG. 19B shows a state machine 1910 that includes states that operate in a bi-directional manner. Accordingly, state A 1912, state B 1914, state C 1916, and state D 1918 may transition between the respective states along illustrative transitions t1-t8. The state machine 1910 may be similar to those shown in the illustrative graph of FIG. 11, but with a state machine instead of a graph.

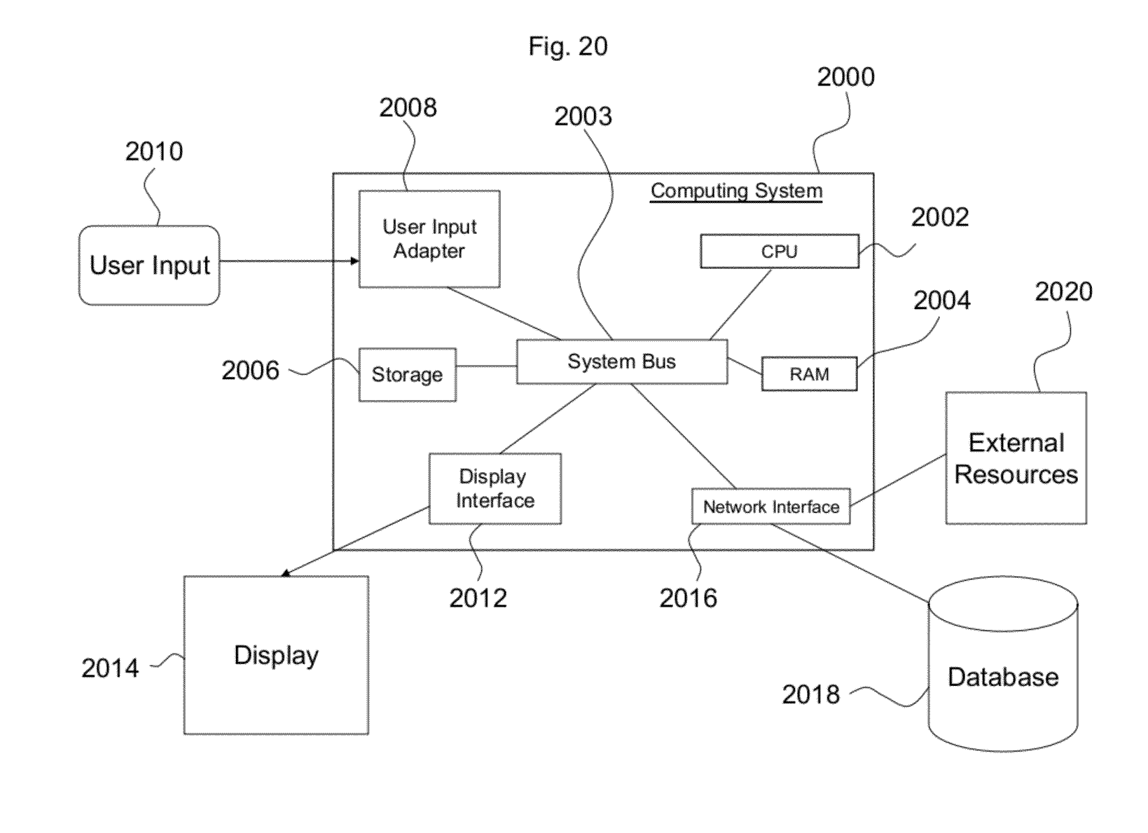

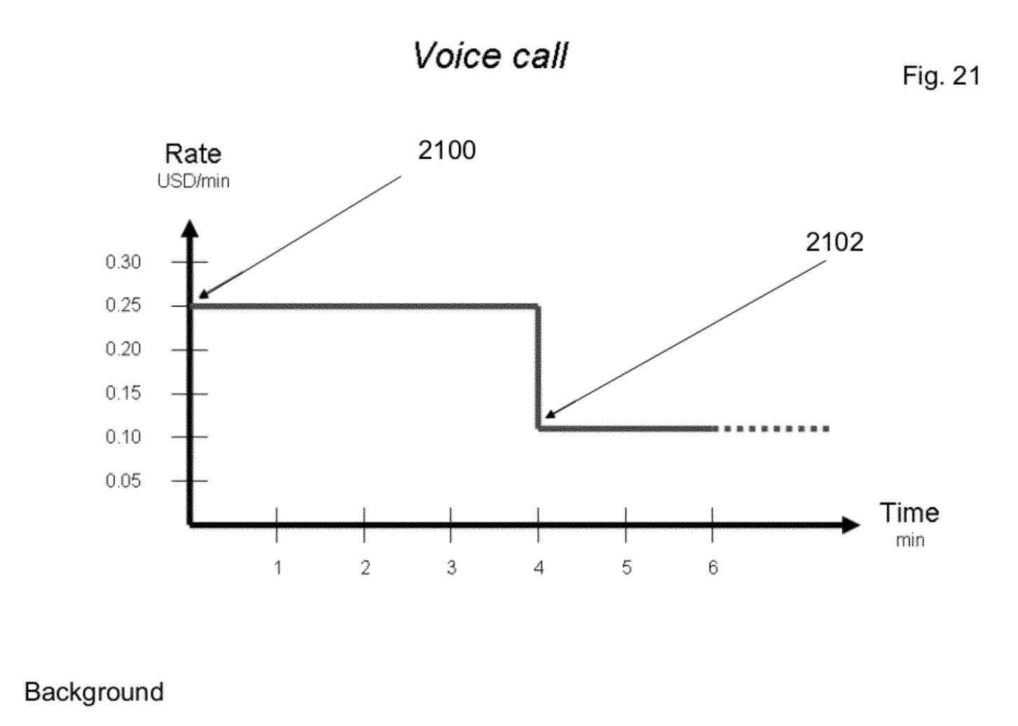

As discussed above, certain example embodiments may be implemented using a machine, e.g., electronic circuitry or a processing system in the form of a computing system or hardware circuit. FIG. 20 is a block diagram of a non-limiting computing system according to certain example embodiments. Computing system 2000 may include a CPU 2002 that communicates with RAM 2004 over a system bus 2003. RAM 2004 may be volatile random access memory and the CPU 2002 may include one or more individual cores that are configured to each handle one or more instructions. The RAM 2004 may store data related to notifications, calculations, thresholds, etc. For example, a suppression list associated with a user may be stored in RAM. Also included in computer system 2000 may be a storage medium 2006 of non-volatile storage. Storage medium 2006 may operate to store data (e.g., history data) of a given user, account, UE, or the like. Data not presently stored in RAM 2004 may be stored in storage 2006 for longer term storage. The computer system 2000 may also include a display interface 2012 (e.g., a video card) that communicates with a display 2014. The display 2014 may display information related to the administration of the computing system. Similarly, computing system may include a user input adapter 2008 that communicates with a user input device 2010 (e.g., a mouse or keyboard) such that an administrator may enter commands, new data, etc into the computing system 2000. The computing system 2000 may include a network interface 2016 that operates to communicate with external resources 2020 and/or a database 2018. In certain example embodiments, the database 2018 may hold historical data related to a user or other types of data that is stored for a long term. External resources may be other types of resources within a mobile network. For example, core network resources.

Although various embodiments have been shown and described in detail, the claims are not limited to any particular embodiment or example. For example, although certain example embodiments may be described in relation to a particular type of telecommunication architecture, it will be appreciated that techniques described herein may be applied to other types of telecommunication architectures—e.g., GSM, Edge, CDMA, IP based systems, etc. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described, for it to be encompassed by the present claims. No claim is intended to invoke 35 U.S.C §112, 6^{th} paragraph unless the words “means for” or “step for” are used. Furthermore, no embodiment, feature, component, or step in this specification is intended to be dedicated to the public regardless of whether the embodiment, feature, component, or step is recited in the claims.

1. A computer implemented method for providing a notification to a user equipment device that is configured to interface with a communications network, the method comprising:
determining a first amount of resources used by a first user equipment device;
calculating a first rate based at least in part on 1) the determined first amount of resources and 2) a first time period;
comparing the first rate against a comparison rate;
triggering a first notification event based on at least the comparison of the first rate against the comparison rate; and
sending a notification message to a second user equipment device based at least in part on the first notification event.

2. The method of claim 1, wherein calculating the first rate is further based on a tariff rate or a price per unit.

3. The method of claim 1, wherein the first user equipment device is the second user equipment device.

4. The method of claim 1, wherein the notification message includes a message suggesting an increase in usage when the first notification event is related to a decreased rate or the notification message includes a message suggesting a decrease in usage when the first notification event is related to an increased rate.

5. The method of claim 1, further comprising suppressing the first notification event based on suppression criteria,
wherein the suppression criteria includes suppressing the first notification event when a previously sent notification based on a similar notification event was sent to the second user equipment device within a predetermined time period.

6. The method of claim 1, wherein the first rate is further based on an average over a sliding window of time.

7. The method of claim 1, wherein the first time period is at least one of a last reservation period, a total session time, and/or an amount of time associated with an account that is associated with the first user equipment device or the second user equipment device.

8. The method of claim 1, further comprising:
determining a second amount of resources used by a user equipment device over a second time period;
calculating a second rate based on the determined second amount of resources and the second time period; and
comparing the calculated second rate against a second predetermined threshold rate,
wherein the comparison rate is a first predetermined threshold rate.

9. The method of claim 8, wherein the first notification event is triggered further based on the comparison of the second rate against the second predetermined threshold rate.

10. The method of claim 8, further comprising:
triggering a second notification event based on at least the comparison of the second rate against the second predetermined threshold rate.

11. The method of claim 10, further comprising prioritizing the first and second notification events according to a predetermined order.

12. The method of claim 10, further comprising suppressing the first or second notification event based on a notification priority order.

13. The method of claim 1, wherein the comparison rate is a second rate and the method further comprises:
determining a second amount of resources used by the user equipment device; and
calculating the comparison rate based at least in part on 1) the determined second amount of resources and 2) a second time period.

14. The method of claim 13, wherein comparing the first rate against the second rate further includes calculating a difference between the first rate and the second rate, calculating an angle of change that is formed by the first and second rates, and/or assigning the first rate and the second rate, respectively, to first and second states of a plurality of states.

15. The method of claim 13, furthering comprising:
classifying the first rate to a first state from among a plurality of states; and
classifying the second rate to a second state from among the plurality of states,
wherein comparing the first rate against the second rate includes a difference between the first state and the second state.

16. A computer implemented method for sending a notification to a user equipment device that is configured to communicate with a communications network, the method comprising:
determining resource usage over first and second time periods;
assigning first and second consumption values, respectively, to first and second consumption levels among a plurality of consumption levels, the assignment based on the determined resource usage over the first and second time periods, respectively;
assigning first and second price per consumption unit values, respectively, to first and second price levels among a plurality of price levels;
assigning the first consumption level and the first price level to a first state of a state table;
assigning the second consumption level and the second price level to a second state of the state table;
triggering a notification event based on a difference between the first state and the second state; and
sending a notification message to the user equipment device based at least in part on the notification event.

17. A computer readable storage medium storing computer-readable instructions for performing a notification method for use on a processing in a communications network that is configured to communicate with a user equipment device, the stored instructions comprising instructions configured to:
determine resource usage over first and second time periods;
assign first and second consumption values, respectively, to first and second consumption levels among a plurality of consumption levels, the assignment based on the determined resource usage over the first and second time periods, respectively;
assign first and second price per consumption unit values, respectively, to first and second price levels among a plurality of price levels;
assign the first consumption level and the first price level to a first state of a state table;
assign the second consumption level and the second price level to a second state of the state table;
trigger a notification event based on a difference between the first state and the second state; and
cause the communications network to send a notification message to the user equipment device based at least in part on the notification event.

18. A node configured to communicate with a communications network that provides communications service to a user equipment device, the node comprising:
a processing system configured to:
determine a first amount of resources used by a first user equipment device;
calculate a first rate based at least in part on 1) the determined first amount of resources and 2) a first time period;
compare the first rate against a comparison rate;
trigger a first notification event based on at least the comparison of the first rate against the comparison rate; and
communicate with the communications network to send a notification message to a second user equipment device based at least in part on the first notification event.

19. The node of claim 18, wherein the calculation of the first rate is further based on a tariff rate or a price per unit.

20. The node of claim 18, wherein the first user equipment device is the second user equipment device.

21. The node of claim 18, wherein the notification message includes a message suggesting an increase in usage when the first notification event is related to a decreased rate or the notification message includes a message suggesting a decrease in usage when the first notification event is related to an increased rate.

22. The node of claim 18, wherein the processing system is further configured to suppress the first notification event based on suppression criteria,
wherein the suppression criteria includes suppression of the first notification event when a previously sent notification based on a similar notification event was sent to the second user equipment device within a predetermined time period.

23. The node of claim 18, wherein the calculation of the first rate is further based on an average over a sliding window of time.

24. The node of claim 18, wherein the first time period is a last reservation period, a total session time, and/or an amount of time associated with an account that is associated with the first user equipment device or the second user equipment device.

25. The node of claim 18, wherein the processing system is further configured to:
determine a second amount of resources used by a user equipment device over a second time period;
calculate a second rate based on the determined second amount of resources and the second time period; and
compare the calculated second rate against a second predetermined threshold rate,
wherein the comparison rate is a first predetermined threshold rate.

26. The node of claim 25, wherein triggering of the first notification event is further based on the comparison of the second rate against the second predetermined threshold rate.

27. The node of claim 25, wherein the processing system is further configured to trigger a second notification event based on at least the comparison of the second rate against the second predetermined threshold rate.

28. The node of claim 27, wherein the processing system is further configured to prioritize the first and second notification events according to a predetermined order.

29. The node of claim 27 wherein the processing system is further configured to suppress the first or second notification event based on a notification priority order.

30. The node of claim 18, wherein the comparison rate is a second rate and the processing system is further configured to:
determine a second amount of resources used by the user equipment device; and
calculate the second rate based at least in part on 1) the determined second amount of resources and 2) a second time period.

31. The node of claim 30, wherein comparison of the first rate against the second rate further includes calculating a difference between the first rate and the second rate, calculating of an angle of change that is formed by the first and second rates, and/or assigning the first rate and the second rate, respectively, to first and second states of a plurality of states.

32. The method of claim 30, wherein the processing system is further configured to:
classify the first rate to a first state from among a plurality of states; and
classify the second rate to a second state from among the plurality of states,
wherein comparison of the first rate against the second rate includes a difference between the first state and the second state.

33. A computer readable storage medium storing computer-readable instructions for performing a notification method for use on a processing system in a communications network that is configured to communicate with a user equipment device, the stored instructions comprising instructions configured to:
determine a first amount of resources used by a first user equipment device;
calculate a first rate based at least in part on 1) the determined first amount of resources and 2) a first time period;
compare the first rate against a comparison rate;
trigger a first notification event based on at least the comparison of the first rate against the comparison rate; and
interface with the communications network to send a notification message to a second user equipment device based at least in part on the first notification event.

34. The medium of claim 33, wherein the calculation of the first rate is further based on a tariff rate or a price per unit.

35. The medium of claim 33, wherein the first user equipment device is the second user equipment device.

36. The medium of claim 33, wherein the notification message includes a message suggesting an increase in usage when the first notification event is related to a decreased rate or the notification message includes a message suggesting a decrease in usage when the first notification event is related to an increased rate.

37. The medium of claim 33, wherein the processing system is further configured to suppress the first notification event based on suppression criteria,
wherein the suppression criteria includes suppression of the first notification event when a previously sent notification based on a similar notification event was sent to the second user equipment device within a predetermined time period.

38. The medium of claim 33, wherein the calculation of the first rate is further based on an average over a sliding window of time.

39. The medium of claim 33, wherein the first time period is a last reservation period, a total session time, and/or an amount of time associated with an account that is associated with the first user equipment device or the second user equipment device.

40. The medium of claim 33, wherein the processing system is further configured to:
determine a second amount of resources used by a user equipment device over a second time period;
calculate a second rate based on the determined second amount of resources and the second time period; and
compare the calculated second rate against a second predetermined threshold rate,
wherein the comparison rate is a first predetermined threshold rate.

41. The medium of claim 40, wherein triggering of the first notification event is further based on the comparison of the second rate against the second predetermined threshold rate.

42. The medium of claim 40, wherein the processing system is further configured to trigger a second notification event based on at least the comparison of the second rate against the second predetermined threshold rate.

43. The medium of claim 40, wherein the processing system is further configured to prioritize the first and second notification events according to a predetermined order.

44. The medium of claim 40, wherein the processing system is further configured to suppress the first or second notification event based on a notification priority order.

45. The medium of claim 33, wherein the comparison rate is a second rate and the processing system is further configured to:
determine a second amount of resources used by the user equipment device; and
calculate the second rate based at least in part on 1) the determined second amount of resources and 2) a second time period.

46. The medium of claim 45, wherein comparison of the first rate against the second rate further includes calculating a difference between the first rate and the second rate, calculating an angle of change that is formed by the first and second rates, assigning the first rate and the second rate, respectively, to first and second states of a plurality of states.

47. The medium of claim 45, wherein the processing system is further configured to:
classify the first rate to a first state from among a plurality of states; and
classify the second rate to a second state from among the plurality of states,
wherein comparison of the first rate against the second rate includes a difference between the first state and the second state.
